(19) United States
(12) Patent Application Publication
(10) Pub. No.: US 2005/0180883 A1
(43) Pub. Date: Aug. 18, 2005

(54) Apparatus for transferring a microplate

(75) Inventors: Yoshio Maeda, Ibaraki (JP); Hideharu Satoh, Tokyo (JP)

Correspondence Address: WOOD, PHILLIPS, KATZ, CLARK & MORTIMER, 500 W. MADISON STREET, SUITE 3800, CHICAGO, IL, 60661, US

(73) Assignee: Cosmotec Co., Ltd.

(21) Appl. No.: 10/780,081

(22) Filed: Feb. 17, 2004

(51) Int. Cl. G01N 35/00

(52) U.S. Cl. 422/63

(57) ABSTRACT

The present invention provides an apparatus for transferring a microplate having a plurality of wells arranged in a matrix of lengthwise and crosswise rows relative to stationary dispenser nozzles spaced at regular intervals in the crosswise direction for dispensing a liquid matter into the wells. The number of the nozzles being smaller than the number of the wells in each crosswise row of the microplate. In a preferred embodiment of the invention, the number of the nozzles corresponds to half the number of the wells in a crosswise row. The apparatus comprises, a support plate on which the microplate is mounted, a means for transferring the support plate forward and backward in the lengthwise direction, and a means for shifting the support plate in the crosswise direction between a first position in which each of the odd or even wells in crosswise rows of the microplate is aligned with correspondingly one of the nozzles in the lengthwise direction, respectively, and a second position in which each of the even or odd wells in crosswise rows of the microplate is aligned with correspondingly one of the nozzles in the lengthwise direction, respectively.

### FIELD OF THE INVENTION

The present invention relates to an apparatus for transferring a microplate.

### BACKGROUND OF THE INVENTION

Microplates having plurality of wells arranged lengthwise and crosswise such as a 12 by 8 matrix, a 24 by 16 matrix have been used for a blood test etc. with dispensing a liquid matter such as a reagent, a sample, etc. into the wells using a set of nozzles in a dispenser system. Conventionally, when dispensing a liquid matter to the wells of the microplate, a certain number of nozzles corresponding to the number of wells in a crosswise row were movelessly set in the crosswise direction at regular intervals and above the transfer course of the microplate along the lengthwise direction, and then the microplate was transferred forward along the course to receive a given amount of the liquid matter in each of wells from the stationary nozzles every crosswise row of the wells. Alternatively, one or more nozzles were moved to the stationary microplate to dispense the matter to the wells of the microplate.

However, when the same number of nozzles as wells in a crosswise row of the microplate were provided on the dispenser system, there were experienced increases in cost and size of the system. On the other hand, when moving one or more nozzles rather than the microplate, a mechanism for moving the nozzles were very complex.

An object of the present invention is to present an apparatus for transferring a microplate without increases in cost and size of the dispenser system even when the number of the nozzles is smaller than that of the wells in a crosswise row of the microplate.

### SUMMARY OF THE INVENTION

The present invention provides an apparatus for transferring a microplate having a plurality of wells arranged in a matrix of lengthwise and crosswise rows relative to stationary dispenser nozzles spaced at regular intervals in the crosswise direction for dispensing a liquid matter into the wells, the number of the nozzles being smaller than the number of the wells in each crosswise row of the microplate comprising: a support plate on which the microplate is mounted; a means for transferring the support plate forward and backward in the lengthwise direction; and a means for shifting the support plate in the crosswise direction between a first position in which each of the odd or even wells in crosswise rows of the microplate is aligned with correspondingly one of the nozzles in the lengthwise direction, respectively, and a second position in which each of the even or odd wells in crosswise rows of the microplate is aligned with correspondingly one of the nozzles in the lengthwise direction, respectively. In a preferred embodiment of the present invention, the number of the nozzles corresponds to half the number of the wells in a crosswise row of the microplate.

In one embodiment of the present invention, the shifting means comprises: one or more guide members to guide the support plate in the crosswise direction; one or more elastic members operative to keep the support plate in the first position and to urge the support plate in the second position back to the first position; a means for moving the support plate in the first position toward the second position along the guide members and against the force of the elastic members after dispensing a liquid matter to all wells aligned with the nozzles in the lengthwise direction in the first position; a means for locking the support plate in the second position when the support plate is being moved by the moving means; and a means for releasing the locking of the support plate in the second position after dispensing a liquid matter to all wells aligned with the nozzles in the lengthwise direction in the second position. The moving means may comprise a roller rotatably attached to the support plate and a diverting member for diverting the support plate from the lengthwise direction to the crosswise direction by contacting with the roller. The locking means may comprise an opening or a recess formed in the support plate, a stopper which can be inserted into the opening when the support plate is in the second position, and a spring always urging the stopper to move toward the opening. The releasing means comprises an engagement member which can pull out the stopper from the opening against the force of the spring.

### BRIEF DESCRIPTION OF THE DRAWINGS

FIG. 1 is a perspective view of an apparatus for transferring a microplate according to one embodiment of the present invention.

FIG. 2 is a perspective view of the apparatus shown in FIG. 1 wherein the microplate was removed.

FIG. 3 is a schematic top view of the apparatus shown in FIG. 1 wherein the upper plate is in the second position.

FIG. 4 is an enlarged cutaway view of the microplate and the nozzles.

FIG. 5 is a partial cross section side view of the apparatus shown in FIG. 1 showing the stopper and the opening.

### DETAILED DESCRIPTION OF THE INVENTION

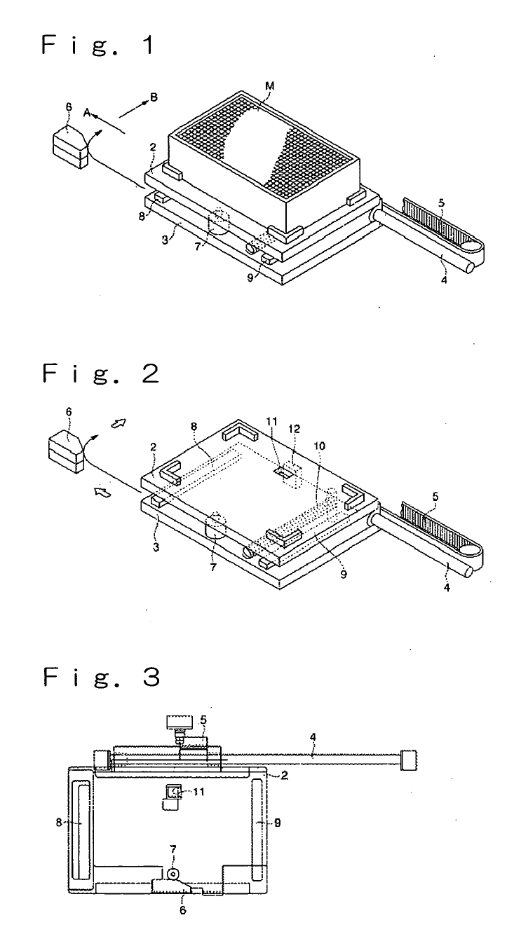

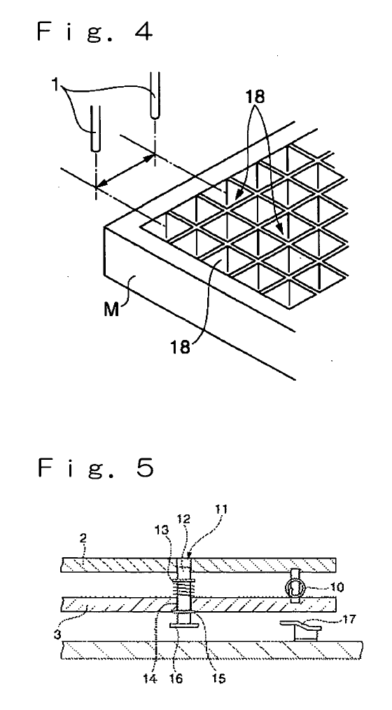

FIGS. 1-3 show a preferred embodiment of an apparatus for transferring a microplate M according to the present invention. The microplate M has a plurality of wells 18 arranged lengthwise and crosswise as a matrix. In this embodiment, the number of the wells 18 is three hundred eighty four, that is, a 16 by 24 matrix. The apparatus is used with a dispenser system having eight nozzles 1 (only two are shown in FIG. 4) which corresponds to half the number of the sixteen wells 18 in a crosswise row. Since the mechanisms of the nozzles and the dispenser system for dispensing a reagent, a sample, etc. are well known in the art, a more detailed description thereof are not described hereinafter.

The apparatus comprises an upper plate or a support plate 2 on which the microplate M is mounted, a lower plate 3 located under the support plate 2, a guide shaft 4 to guide the lower plate 3 with the upper plate 2 in lengthwise direction A, and an endless belt 5 coupled to the lower plate 3 and a stepping motor (not shown) for driving the belt to transfer the lower plate 3 with the upper plate 2 forward and backward along the guide shaft 4, or along on the lengthwise transfer course.

As shown in FIGS. 1 and 2, there is a cam or a diverting member 6 located on the transfer course ahead of the plates 2, 3. On the other hand, a roller 7 is rotatably attached on the under surface of the upper plate 2. In addition, between the upper and lower plates 2, 3, a guide mechanism is provided consisting of slide rails 8, 9 fixed on the top surface of the lower plate 3 and rail receivers (not shown) fixed on the under surface of the upper plate 2 in order to guide and slide the upper plate 2 in the crosswise direction B relative to the lower plate 3. If the roller 7 impinges against the cam 6 when the lower plate 3 with the upper plate 2 is advancing on the lengthwise transfer course, the upper plate 2 will be moved to the right in the direction B relative to the lower plate 3 along the slide rails 8, 9 while the roller 7 is rotating and moving on the inclined surface of the cam 6.

Additionally, the upper and lower plates 2, 3 are connected each other with a spring 10 provided therebetween. The spring 10 operates so as to keep the upper plate 2 in an initial position or a first position in the crosswise direction B without contacting between the cam 6 and the roller 7, and to urge the upper plate 2 out of the the first position with contacting between the cam 6 and the roller 7 back to the first position.

Furthermore, as best shown in FIGS. 2 and 5, the upper plate 2 is provided with an opening 11, and the lower plate 3 is provided with a slot 14 and a stopper 12 through the slot 14. The stopper 12 is always urged upwardly by a coil spring 13 put around the stopper 12 between an upper collar 13 and the top surface of the plate 3. A lower collar 15 of the stopper 12 prevents the stopper 12 from going out of the slot 14. The stopper 12 will be inserted into the opening 11 of the upper plate 2 by the force of the spring 13 upon overlapping the stopper 12 and the opening 11 after the upper plate 2 is moved in direction B from the first position by the interaction between the roller 7 and the cam 6. As a result, the upper plate 2 will be stopped moving in the direction B, and this determines a second position of the upper plate 2 relative to the first position.

In FIG. 5, there is a flange 16 at the lower end of the stopper 12, on the other, an engagement member 17 is located on a stationary plate under the lower plate 3 in order to pull out the stopper 12 from the opening 11 against the forth of the spring 13 by engaging with the flange 16 when the stopper 12 meets the engagement member 17 as described below. If the stopper 12 escapes from the opening 11, the upper plate 12 will be moved in the direction B by the force of the spring 10 to return to the first position from the second position.

In operation, the microplate M having the 16×24 wells 18 is positioned in place on the upper plate 2, and the eight nozzles 1 corresponding to half the number of the wells 18 but having double intervals in a crosswise row are movelessly set above the lengthwise transfer course ahead of the upper and lower plates 2, 3 in which in the lengthwise direction A each of the nozzles 1 is aligned with each of the odd wells or the 1st, 3rd, 5th, 7th, 9th, 11th, 13th and 15th wells 18 in crosswise rows of the microplate M, respectively. Firstly, the microplate M on the upper plate 2 is moved forward on the lengthwise transfer course along the guide shaft 4 by the action of the endless belt 5 to the lower plate 3, while during this movement the the odd wells 18 receive therein a given amount of the liquid matter from the nozzles 1 every crosswise row of the wells 18. Immediately after the last crosswise row of the wells 18 finishes receiving the matter from the nozzles 1, the roller 7 impinges against the cam 6. Thereby the microplate M with the upper plate 2 is moved in the direction B the distance between the midpoints of the adjacent wells 18, and then stopped moving by the stopper 12 entering the opening 11 of the upper plate 2 so that the microplate M is shifted to the second position from the first position. In the second position, in the lengthwise direction A each of the nozzles 1 is aligned with each of the even wells or the 2nd, 4th, 6th, 8th, 10th, 12th, 14th and 16th wells 18 in crosswise rows of the microplate M, respectively.

Next, while the microplate M is moved backward in direction A by reversely driving the endless belt 5, the even wells 18 receive therein a given amount of the liquid matter from the nozzles 1 every crosswise row of the wells 18. After the last crosswise row of the wells 18 in the backward movement finished receiving the matter from the nozzles 1, the flange 16 of the stopper 12 engages with the engagement member 17 (see FIG. 5) to pull down the stopper 12 out of the opening 11 against the force of the spring 13. Thereby the microplate M and the upper plate 2 returns to the first position from the second position in the direction B by the force of the spring 10.

As discussed above, according to the present invention, since the number of nozzles is smaller than that of the wells in a crosswise row of the microplate and the nozzles are not moved, the dispenser system can be simple, inexpensive and compact.

It will be apparent for those skilled in the art that various modifications may be possible.

For example, a liquid dispensing system having a crosswise row of liquid dispensing nozzles arranged at uniform intervals can be used for three different types of microplates, first type being provided with crosswise rows each having the same number of wells at the same intervals as the nozzles; second type being provided with crosswise rows each having two times as large in number as the nozzles but at one half intervals of the nozzles; and the third type being provided with crosswise rows each having three times as large in number as the nozzles but at one third intervals of the nozzles.

In such case, the means of moving the support plate may be moved in the crosswise direction B from the first position to a second position and then to a third position to so that the upper plate can be indexed between three positions spaced by one third of the interval of the nozzles. Correspondingly, two locking means and unlocking means similar to those explained in the above embodiment are necessary in such modification.

1. An apparatus for transferring a microplate having a plurality of wells arranged in a matrix of lengthwise and crosswise rows relative to stationary dispenser nozzles spaced at regular intervals in the crosswise direction for dispensing a liquid matter into the wells, the number of the nozzles being smaller than the number of the wells in each crosswise row of the microplate comprising:
a support plate on which the microplate is mounted;
a means for transferring the support plate forward and backward in the lengthwise direction; and
a means for shifting the support plate in the crosswise direction between a first position in which each of the odd or even wells in crosswise rows of the microplate is aligned with correspondingly one of the nozzles in the lengthwise direction, respectively, and a second position in which each of the even or odd wells in crosswise rows of the microplate is aligned with correspondingly one of the nozzles in the lengthwise direction, respectively.

2. An apparatus of claim 1, wherein the number of the nozzles corresponds to half the number of the wells in a crosswise row of the microplate.

3. An apparatus of claim 1 or 2, wherein the shifting means comprises:
one or more guide members to guide the support plate in the crosswise direction;
one or more elastic members operative to keep the support plate in the first position and to urge the support plate in the second position back to the first position;
a means for moving the support plate in the first position toward the second position along the guide members and against the force of the elastic members after dispensing a liquid matter to all wells aligned with the nozzles in the lengthwise direction in the first position;
a means for locking the support plate in the second position when the support plate is being moved by the moving means; and
a means for releasing the locking of the support plate in the second position after dispensing a liquid matter to all wells aligned with the nozzles in the lengthwise direction in the second position.

4. An apparatus of claim 3, wherein the moving means comprises a roller rotatably attached to the support plate and a diverting member for diverting the support plate from the lengthwise direction to the crosswise direction by contacting with the roller.

5. An apparatus of claim 3, wherein the locking means comprises an opening or a recess formed in the support plate, a stopper which can be inserted into the opening when the support plate is in the second position, and a spring always urging the stopper to move toward the opening.

6. An apparatus of claim 5, wherein the releasing means comprises an engagement member which can pull out the stopper from the opening against the force of the spring.
